(19) United States
(12) Patent Application Publication
(10) Pub. No.: US 2016/0127286 A1
(43) Pub. Date: May 5, 2016

(54) Apparatus and method for secure elective message tag provisioning

(71) Applicant: Barbara Ann Fox, Palm Beach Gardens, FL (US)

(72) Inventor: Barbara Ann Fox, Palm Beach Gardens, FL (US)

(21) Appl. No.: 14/121,904

(22) Filed: Nov. 1, 2014

(51) Int. Cl. H04L 12/58; H04L 29/08; G06F 17/30; G06Q 50/00

(52) U.S. Cl. CPC H04L 51/10; G06Q 50/01; H04L 67/02; H04L 51/18; G06F 17/30864; G06F 17/30554

(57) ABSTRACT

A computer-implemented method and apparatus for the secure provisioning of elective message tags in a digital environment.

### FIELD OF THE INVENTION

The present invention pertains to an improvement in the technical solution for providing elective message tagging, and in particular the present invention pertains to an apparatus and method for elective message tagging, which provides enhanced products and/or services for engineering, communications, entertainment, and other industries and individuals who or which utilize same.

### BACKGROUND OF THE INVENTION

Engineers, communications professionals, and marketers seeking to manage, inform, offer, and direct application or systems users, benefit from the use of message tags. Message tags contribute to the enablement of the conveyance of the message as well as information relevant to the content, or to the receiver of the message. Efficiently and effectively providing message tagging solutions is one fundamental challenges faced when architecting and engineering systems to provided benefits to message recipients. By example, message tags can contain routing information, protocols, permissions, hyperlinks, advertisements, educational information, or other valuable data to the message recipient to assist with non-commercial and commercial purposes. With ever increasingly complex engineering, communications, and marketing endeavors undertaken, there is a continual increase the importance of and challenge associated with efficient and effective tagging.

The ability to effectively associate and efficiently pair a tag to a message can lead to the development of products and services in the United States and throughout the rest of the world that would benefit industry and individuals. Throughout past decades, innovations in tagging technologies have enabled the founding and growth of industries and improved lives of individuals due to the ability to improve the management, regulation, guidance, information, and offers associated with messages, while mitigating the erred, malicious, misdirected, and/or undesired messages.

Typically, engineers, communications professionals, and marketers have to rely on a limited scope of supply side paradigms for application related message tagging is needed. An example of this is where, marketers profile the personal data of individuals to submit an unrequested advertisement to an individual in a computing application in conjunction with the publishing of content of that application. Today, these practices often result in control disequilibrium between providers of messages; the enabling technology providers of such services, and the recipients of message tags.

The ability to apply a secure, versatile, controllable, customizable, and a readily available tagging system controlled by the message recipient would make the benefits of tagging more widely available to developers and users of engineered systems, devices, products, and services. The result being that many more people would benefit from improved systems, products, and services utilizing message tags.

### SUMMARY OF THE INVENTION

The present invention pertains to an improvement in the technical solution for providing elective message tagging, and in particular the present invention pertains to an apparatus and method for elective message tagging, which provides enhanced products and/or services for engineering, communications, entertainment, and other industries and individuals who or which utilize same.

The present invention utilizes a computer implemented system with the following elements; an input unit, a storage unit, a central processing unit, wherein the central processing unit further includes an arithmetic logic unit and a control unit, and an output unit, wherein the output unit further includes communications unit, and wherein the functionality of such elements is understood to be accepting data or instructions as input, storing data and instruction, processing data as per the instructions, controlling all operations pertaining to the computer system, and giving results in the form of output.

The present invention provides an apparatus and method of use by which message tagging can be initiated or controlled on the receiver side of the message tag, also known as the demand side. By creating a mechanism with receiver sided tagging that can be readily implemented in a plethora of applications will enable the benefits of tagging to be achieved by many more individuals in the systems, devices, and products they use.

The present invention provides an apparatus and method of use by which a demand side, receiver controlled message tagging transaction can occur in conjunction with a communication of a message.

The present invention can be constructed as an apparatus or be a method that can be utilized to provide a comprehensive message tagging platform and/or service by which individuals, subscribers, registrants, and/or agents thereof can elect to, and register for receiving messages with information, data, communications, and offers, wherein the elected message tag is attached to, embedded in, and/or otherwise associated with a digital message or communication.

The present invention can be constructed as an apparatus or be a method that can be utilized in conjunction with computing platforms and systems.

The present invention can be constructed as an apparatus or be a method that can be utilized to facilitate services that occur in real-time.

The present invention can be constructed as an apparatus or be a method that can be utilized in conjunction with commercial transactions.

The present invention can be constructed as an apparatus or be a method that can be utilized with near field communications, on-premise communications, and personal communications services and devices.

The present invention can be constructed as an apparatus or be a method that can be utilized in a network environment.

The present invention can be constructed as an apparatus or be a method that can be utilized in machine to machine communications.

The present invention can be constructed as an apparatus or be a method that can be utilized in conjunction with a monitoring system.

The present invention can be constructed as an apparatus or be a method that can be utilized in conjunction with an inventory management system.

The present invention can be constructed as an apparatus or be a method that can be utilized in conjunction with a service management system.

The present invention can be constructed as an apparatus or be a method that can be utilized in conjunction with movement sensing systems.

The present invention can be constructed as an apparatus or be a method that can be utilized in conjunction with geo-location systems.

The present invention can be constructed as an apparatus or be a method that can be utilized with a display trigger within a computing app.

The present invention can be constructed as an apparatus or be a method that can be customized in the display of a computing app.

The present invention can be constructed as an apparatus or be a method that can be utilized to enable users to elect a message tag.

The present invention can be constructed as an apparatus or be a method that can be configured to permit reactive, proactive, or dynamic changes to its elective message tagging parameters.

The present invention can be constructed as an apparatus or be a method that can be utilized in conjunction with contextual data.

The present invention can be constructed as an apparatus or be a method that can be utilized in conjunction with financial, news or other data providing systems.

The present invention can be constructed as an apparatus or be a method that can be utilized in conjunction with data analytics systems.

The present invention can be constructed as an apparatus or be a method that can be utilized in conjunction with security information systems.

The present invention can be constructed as an apparatus and method to deliver multiple units of elective message tags.

The present invention can be constructed as an apparatus and method to deliver hyperlinks as components of elective message tags.

The present invention can be constructed as an apparatus or be a method that can be utilized in conjunction with digital media distribution systems.

The present invention can be constructed as an apparatus or be a method that can be utilized in conjunction with a network based subscription management system.

The present invention can be constructed as an apparatus or be a method that can be utilized in conjunction with transmitting, receiving, and/or scanning devices.

The present invention can be constructed as an apparatus or be a method that can be utilized in conjunction with a fulfillment system.

The present invention can be constructed as an apparatus Or be a method that can be utilized in conjunction with a plurality of end-point devices.

The present invention can be constructed as an apparatus or be a method that can be utilized over any suitable communication network and/or, system.

The present invention can be constructed as an apparatus or be a method that can be utilized over any other suitable combination of communication networks.

The present invention can be constructed as an apparatus or be a method that can be utilized in conjunction with commercial vouchers.

The present invention can be constructed as an apparatus or be a method that can be utilized in conjunction with tickets.

The present invention can be constructed as an apparatus or be a method that can be utilized in conjunction with coupons.

The present invention can be constructed as an apparatus or be a method that can be utilized in conjunction with any point-of-sale transaction device.

The present invention can be constructed as an apparatus or be a method that can be utilized in conjunction with any point-of-sale transaction device.

The present invention can be constructed as an apparatus or be a method that can be utilized in conjunction with public digital display devices and/or services.

The present invention can be constructed as an apparatus or be a method that can be utilized in conjunction with an ad network system.

The present invention can be constructed as an apparatus or be a method that can be utilized in conjunction with a mobile message delivery system.

The present invention can be constructed as an apparatus or be a method that can be utilized in conjunction with an app directory system.

The present invention can be constructed as an apparatus or be a method that can be utilized in conjunction with a dynamic folder system.

The present invention can be constructed as an apparatus or be a method that can be utilized in conjunction with third-party applications.

The present invention can be constructed as an apparatus or be a method that can be utilized in conjunction with intelligent agents.

The present invention can be constructed as an apparatus or be a method that can be utilized in conjunction with pre-restriction functionality.

The present invention can be constructed as an apparatus or be a method that can be utilized in conjunction with limitation functionality.

The present invention can be constructed as an apparatus or be a method that can be utilized in conjunction with a financial transaction processing system.

The present invention can be constructed as an apparatus or be a method that can be utilized in conjunction with a banking system.

The present invention can be constructed as an apparatus or be a method that can be utilized in conjunction with a value storage system.

The present invention can be constructed as an apparatus or be a method that is programmable.

Other objects and advantages of the present invention will be apparent to those skilled in the art upon a review of the Description of the Preferred Embodiment taken in conjunction with the Drawings which follow.

### DESCRIPTION OF THE PREFERRED EMBODIMENTS

The present invention pertains to an apparatus and method for elective message tagging, which provides the secure and reliable delivery of elective message tags.

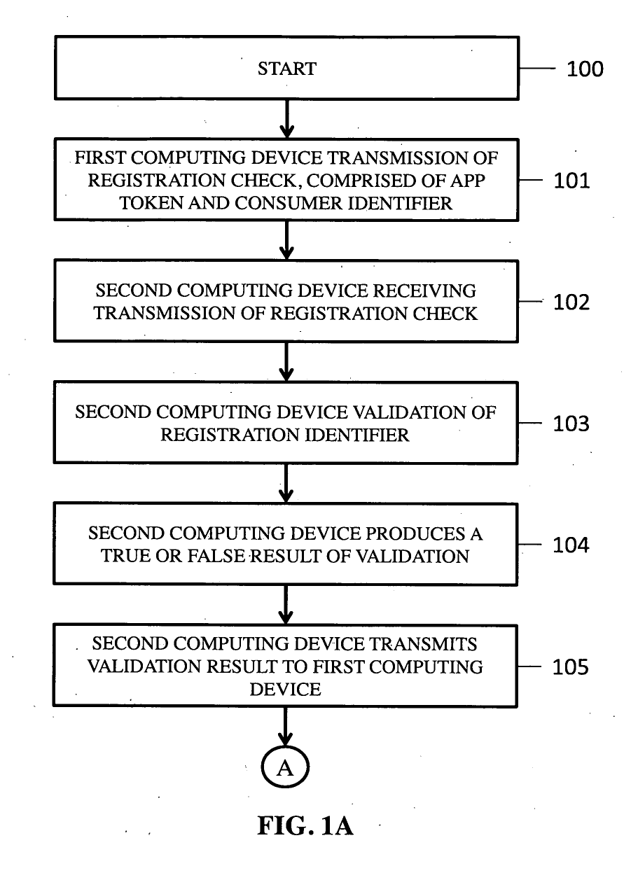

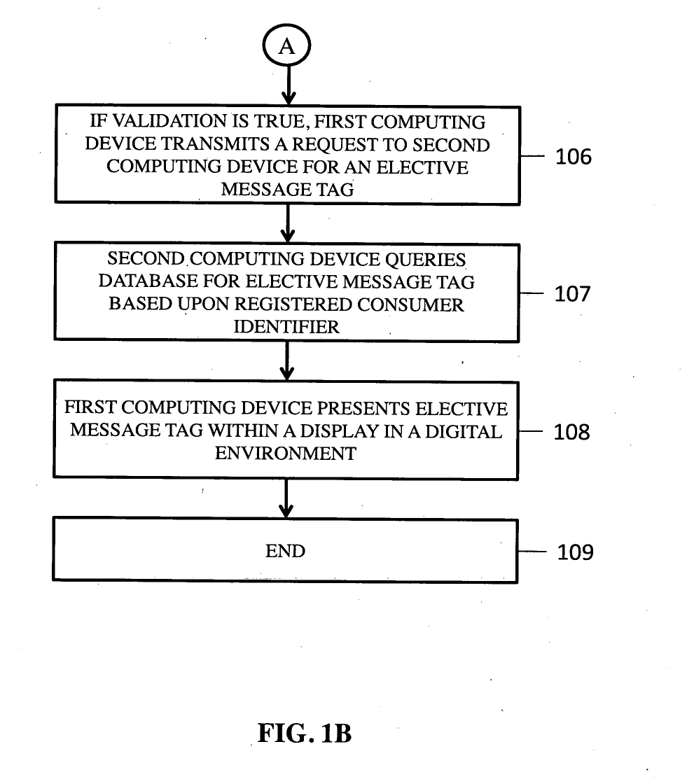

FIGS. 1A and 1B illustrate a flow diagram of a preferred embodiment of the present invention wherein the present invention is utilized to securely provision elective message tags.

The operation of the embodiment of FIGS. 1A and 1B commences at Step 100. At Step 101, a first computing device transmits a registration check. The registration check is an app token and a consumer identifier. The app token is a permission-based identifier that uniquely identifies the app. The consumer identifier is a unique set of credentials of a registered'individual user of the service. At step 102 a second computing device receives the transmission initiated at Step 101 of the app token and a consumer identifier. At Step 103 the second computing device performs a validation process of the app token and the consumer identifier. At Step 104 the validation process produces a true or false result. At Step 105 the second computing device transmits the result of the validation to the first computing device. Where the validation result received at the first computing device is true, at Step 106 the true result causes the first computing device to transmit a request to the second computing device for an elective message tag. Upon receipt of the request, the second computer at Step 107 queries a database for an elective message tag associated with the individual identified by the consumer identifier and returns said elective message tag to the first computing device. At Step 108 the first computing device presents the elective message tag within a display in a digital environment. Thereafter, the operation of the embodiment of FIGS. 1A and 1B will cease at Step 109.

In a preferred embodiment, the method of present invention facilitates receiving an elective message tag as a presentation within a display in a digital environment, comprising the steps of: transmitting from a first computing device a registration check, where said registration check is an app token and a consumer identifier; causing a second computing device to receive said transmission of an app token and a consumer identifier; causing second computing device to perform a validation of the app token and the consumer identifier, whereby the validation produces a true or false result; causing the second computing device to transmit the result of the validation to the first computing device; causing a the first computing device to transmit, in the case of a true validation result, a request to the second computing device for an elective message tag; causing second computing device to query a database of consumer message tag elections, where consumer elective message tag is identified based upon registered consumer identifier; causing second computing device to transmit elective message tag; causing first computing device to present elective message tag within a display in a digital environment.

In a preferred embodiment of the apparatus and method of present invention the elective message tag is located, generated, or stored at the second computing device.

In a preferred embodiment of the apparatus and method of present invention the consumer identifier is one of is a mobile telephone number, an email, a third-party identification element, or a federated identification.

In a preferred embodiment of the apparatus and method of present invention the consumer identifier is preprogrammed to transmit from the first computing device.

In a preferred embodiment of the apparatus and method of present invention the first computing device is able to store instructions for elective message tag presentation.

In a preferred embodiment of the apparatus and method of present invention the second computing device is able to store instructions for elective message tags.

In a preferred embodiment of the apparatus and method of present invention the first and second computing devices are able to provide access to hyperlinks.

In a preferred embodiment of the apparatus and method of present invention the first and second computing devices are able to calculate and record elective message tag data.

In a preferred embodiment of the apparatus and method of present invention the first computing device is a cloud based computing device.

In a preferred embodiment of the apparatus and method of present invention the second computing device is a cloud based computing device.

In a preferred embodiment of the apparatus and method of present invention hyperlinks are components of elective message tags.

In a preferred embodiment of the apparatus and method of present invention the digital environment of the services provider of the first computing device exists Within a virtual premise.

In a preferred embodiment of the apparatus and method of present invention the digital environment of the services provider of the second computing device exists within a virtual premise.

In a preferred embodiment of the apparatus and method of present invention the communication between the first computing device and the second computing device are encrypted.

In a preferred embodiment of the apparatus and method of present invention the first computing device and the second computing device use decryption software.

In a preferred embodiment of the apparatus and method of present invention the first and second computing devices store the inventory of elective message tags and message tag service providers.

In a preferred embodiment, the apparatus of present invention facilitates receiving an elective message tag as a presentation within a display in a digital environment, comprising: two computing devices, wherein first computing device transmits a registration check, where said registration check is an app token and a consumer identifier; where a second computing device receives said transmission of an app token and a consumer identifier; wherein second computing device performs a validation of the app token and the consumer identifier, whereby the validation produces a true or false result; wherein the second computer transmits the result of the validation to the first computing device; whereby the first computing device transmits, in the case of a true validation result, a request to the second computing device for an elective message tag; wherein second computing device queries a database of consumer message tag elections, where consumer elective message tag is identified based upon registered consumer identifier; whereby second computing device transmits elective message tag; wherein first computing device presents elective message tag within a display in a digital environment.

In a preferred embodiment of the apparatus and method of present invention the first transmission of a registration check originates at public computing device.

In a preferred embodiment of the apparatus and method of present invention the transmission of the elective message tag terminates at a public computing device.

In a preferred embodiment of the apparatus and method of present invention, a computer program product comprises a computer usable medium having control logic stored therein for causing computers to receive an elective message tag as a presentation within a display in a digital environment comprising: a first computer readable program code means for transmitting from a first computing device a registration check; where said registration check is an app token and a consumer identifier; second computer readable program code means for causing a second computing device to receive said transmission of an app token and a consumer identifier; second computer readable program code means for causing second computing device to perform a validation of the app token and the consumer identifier, whereby second computer readable program code validates and produces a true or false result; second computer readable program code means for causing the second computer to transmit the result of the validation to the first computing device; first computer readable program code means for causing the first computing device to transmit, in the case of a true validation result, a request to the second computing device for an elective message tag; second computer readable program code means for causing second computing device to query a database of consumer message tag elections, where consumer elective message tag is identified based upon registered consumer identifier; second computer readable program code means for causing second computing device to transmit elective message tag; first computer readable program code means for causing first computing device to present elective message tag within a display in a digital environment.

In a preferred embodiment of the apparatus and method of present invention the first computer has readable program code mean's for causing the first computer to execute a computerized command for recording of the presentation of the elective message tag.

What is claimed is:

1. A method for facilitating the receiving of an elective message tag as a presentation within a display in a digital environment, comprising the steps of: transmitting from a first computing device a registration check, where said registration check is an app token and a consumer identifier; causing a second computing device to receive said transmission of an app token and a consumer identifier; causing second computing device to perform a validation of the app token and the consumer identifier, whereby the validation produces a true or false result; causing the second computing device to transmit the result of the validation to the first computing device;
causing a the first computing device to transmit, in the case of a true validation result, a request to the second computing device for an elective message tag; causing second computing device to query a database of consumer message tag elections, where consumer elective message tag is identified based upon registered consumer identifier; causing second computing device to transmit elective message tag to first computing device; causing first computing device to present elective message tag within a display in a digital environment.

2. The method of claim 1, wherein the elective message tag is located, generated, or stored at the second computing device.

3. The method of claim 1, wherein the consumer identifier is one of is a mobile telephone number, an email, a third-party identification element, or a federated identification.

4. The method of claim 1, where the consumer identifier is preprogrammed to transmit from the first computing device.

5. The method of claim 1, wherein the first computing device is able to store instructions for elective message tag presentation.

6. The method of claim 1, wherein the second computing device is able to store instructions for elective message tags.

7. The method of claim 1, wherein the first and second computing devices are able to provide access to hyperlinks.

8. The method of claim 1, wherein the first and second computing devices are able to calculate and record elective message tag data.

9. The method of claim 1, wherein the first computing device is a cloud based computing device.

10. The method of claim 1, wherein the second computing device is a cloud based computing device.

11. The method of claim 1, wherein hyperlinks are components of elective message tags.

12. The method of claim 1, wherein the first computing device exists within a virtual premise.

13. The method of claim 1, wherein the communication between the first computing device and the second computing device are encrypted.

14. The method of claim 1, wherein the first computing device and the second computing device use decryption software.

15. The method of claim 1, wherein the first and second computing devices store the inventory of elective message tags and displays within in a digital environment.

16. An apparatus for facilitating the receiving of an elective message tag as a presentation within a display in a digital environment, comprising: two computing devices, wherein first computing device transmits a registration check, where said registration check is an app token and a consumer identifier; where a second computing device receives said transmission of an app token and a consumer identifier; wherein second computing device performs a validation of the app token and the consumer identifier, whereby the validation produces a true or false result; wherein the second computing device transmits the result of the validation to the first computing device; whereby the first computing device transmits, in the case of a true validation result, a request to the second computing device for an elective message tag; wherein second computing device queries a database of consumer message tag elections, where consumer elective message tag is identified based upon registered consumer identifier; whereby second computing device transmits elective message tag to first computing device; wherein first computing device presents elective message tag within a display in a digital environment.

17. The apparatus of claim 16, wherein the first transmission of a registration check originates at public computing device.

18. The apparatus of claim 16, wherein the transmission of the elective message tag terminates at a public computing device.

19. A non-transitory computer program product comprising a computer usable medium having control logic stored therein for causing computers to receive an elective message tag as a presentation within a display in a digital environment comprising: a first computer readable program code means for transmitting from a first computing device a registration check, where said registration check is an app token and a consumer identifier; second computer readable program code means for causing a second computing device to receive said transmission of an app token and a consumer identifier; second computer readable program code means for causing second computing device to perform a validation of the app token and the consumer identifier, whereby second computing device readable program code validates and produces a true or false result; second computing device readable program code means for causing the second computer to transmit the result of the validation to the first computing device; first computer readable program code means for causing the first computing device to transmit, in the case of a true validation result, a request to the second computing device for an elective message tag; second computing device readable program code means for causing second computing device to query a database of consumer message tag elections, where consumer elective message tag is identified based upon registered consumer identifier; second computing device readable program code means for causing second computing device to transmit elective message tag to first computing device; first computing device readable program code means for causing first computing device to present elective message tag within a display in a digital environment.

20. The apparatus of claim 19 where the first computing device has readable program code means for causing the first computer to execute a computerized command for recording of the presentation of the elective message tag.
